(19) United States
(12) Patent Application Publication
(10) Pub. No.: US 2004/0078799 A1
(43) Pub. Date: Apr. 22, 2004

(54) Interpartition communication system and method

(76) Inventors: Maarten Koning, Bloomfield (CA); Vincent Hue, Vannes (FR); Thierry Preyssler, Oakland, CA (US); Andrew Gaiarsa, Carp (CA)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/273,305

(22) Filed: Oct. 17, 2002

(51) Int. Cl. G06F 9/00

(52) U.S. Cl. 719/313

(57) ABSTRACT

A computer system and method for operating a computer are provided which includes a core operating system and a system space having a number of memory locations. The core operating system is arranged to create a number of protection domains to partition the system space into a core operating system space and a plurality of partitions. A partition operating system and a partition user application is provided in each partition, and each partition operating system provides resource allocation services to the respective partition user application within the partition. The system also includes an interpartition communication system. The interpartition communication system interacts with the core operating system and each partition operating system to deliver messages between partitions.

### CROSS REFERENCE TO RELATED APPLICATIONS

This application is related to U.S. application Ser. No. ______ [DDK ATTORNEY DOCKET NO. 218.1045], entitled A TWO-LEVEL OPERATING SYSTEM ARCHITECTURE and U.S. application Ser. No. ______ [DDK ATTORNEY DOCKET NO. 218.1043], entitled HEALTH MONITORING SYSTEM FOR A PARTITIONED ARCHITECTURE, both filed on even date herewith, and the entire disclosures of which are hereby incorporated by reference in their entirety.

### BACKGROUND INFORMATION

A computing environment comprising, for example, a CPU, memory and Input/Output (I/O) devices, typically includes an operating system to provide a way to control the allocation of the resources of the environment. Traditional multitasking operating systems (e.g., UNIX, Windows) have been implemented in computing environments to provide a way to allocate the resources of the computing environment among various user programs or applications that may be running simultaneously in the computing environment. The operating system itself comprises a number of functions (executable code) and data structures that may be used to implement the resource allocation services of the operating system.

Certain operating systems, called “real-time operating systems,” have been developed to provide a more controlled environment for the execution of application programs. Real-time operating systems are designed to be “deterministic” in their behavior—i.e., responses to events can be expected to occur within a known time of the occurrence of the event, without fail. Determinism is particularly necessary in “mission-critical” and “safety-critical” applications, where the outcome of event responses is essential to proper system function. Real-time operating systems are therefore implemented to execute as efficiently as possible with a minimum of overhead. As a result, prior real-time operating systems have typically employed relatively simplistic protection models for system and user processes—typically all processes execute in the same space, thus allowing direct access to all system resources by all user tasks (system calls can be made directly). This real time operating system model provides the fastest execution speed, but is deficient in providing system protection.

In order to improve system protection, it has been proposed to provide an operating system that implements a “protection domain” architecture. VxWorks®AE, marketed by Wind River Systems of Alameda, California, is an example of such a protection domain system. Basically, the protection domain system segregates the computing environment into a number of “protection domains.” Each protection domain is a “container” for system resources, executable code and data structures, as well as for executing tasks and system objects (such as semaphores and message queues). Each resource and object in the system is “owned” by exactly one protection domain. The protection domain itself is a self-contained entity, and may be isolated from other system resources and objects to prevent tasks executing in the protection domain from potentially interfering with resources and objects owned by other protection domains (and vice versa).

The protection domain system of VxWorks®AE also, however, provides mechanisms by which tasks executing in one protection domain may access resources and objects contained in a separate protection domain. Each protection domain includes a “protection view” that defines the system resources and objects to which it has access (i.e., the resources and objects which it can “see”). By default, each protection domain has a protection view that includes only the system resources and objects contained within that protection domain. However, a protection domain may acquire access to the resources of other protection domains by “attaching” to these protection domains. When a first protection domain has obtained “unprotected attachment” to a second protection domain, the second protection domain is added to the protection view of the first protection domain. Executable code in the first protection domain may use “unprotected links” to functions selected in the second protection domain, allowing tasks executing in the first protection domain to use the resources and access the objects of the second protection domain with a minimum of execution overhead.

Unrestricted access by all tasks executing in one protection domain to all the resources and objects of another protection domain may not be desirable, however, for reasons of system protection and security. The VxWorks®AE protection domain system therefore provides a further mechanism whereby individual tasks executing in a first protection domain may access resources or objects contained in a second protection domain, but without adding the second protection domain to the protection view of the first protection domain. This access is achieved by “protected attachment” of the first protection domain to the second protection domain via a “protected link” between executable code in the first protection domain and selected functions in the second protection domain. Using the protected link, a task running in the first protection domain may, for example, make a direct function call to a function existing in the second protection domain, without the need to alter the protection view of the first protection domain. Tasks in the first protection domain are prevented from accessing the second protection domain except through this protected link, thus preventing unauthorized accesses of functions and data in the second protection domain. Protected linking can be achieved without the need to use different code instructions for protected and unprotected accesses (increasing implementation flexibility), and without the need to create separate tasks in the protected protection domain to perform the desired actions.

Such a protection domain system allows the operating system to dynamically allocate system resources among processes and flexibly implements and enforces a protection scheme. This protection scheme can be formulated to control the impact of poorly written applications, erroneous or disruptive application behavior, or other malfunctioning code, on the operating system and other applications running in the computer system. The protection domain approach accomplishes the protection results in a manner that is transparent to application developers, and incurs minimal execution overhead.

While the known protection domain system achieves a significant advance in system protection, additional capabilities would be desirable. For example, in safety-critical applications, it would be desirable to separate user applications into discrete partitions so that the impact of any erroneous or disruptive behavior of a particular user application can be contained to the malfunctioning application itself.

### SUMMARY

In accordance with a first embodiment of the present invention, a computer system and method for operating a computer are provided which includes a core operating system and a system space having a number of memory locations. The core operating system is arranged to partition the system space into a core operating system space and a number of partitions which include a plurality of partitions. A partition operating system and a partition user application is provided in each partition, and each partition operating system provides resource allocation services to the respective partition user application within the partition. The system also includes an interpartition communication system. The interpartition communication system interacts with the core operating system and each partition operating system to deliver messages between partitions.

In accordance with a second embodiment of the present invention, a computer system and method for operating a computer are provided which include a core operating system and a system space having a number of memory locations. The core operating system is arranged to partition the system space into a core operating system space and a plurality of partitions. A partition operating system and a partition user application pair are provided in each partition and the partition operating system, partition user application pairs of the partitions are spatially partitioned from each other. The system also includes an interpartition communication system. The interpartition communication system interacts with the core operating system and each partition operating system to deliver messages between partitions.

In accordance with a third embodiment of the present invention, a computer system and method for operating a computer system are provided. The system includes a core operating system and a system space having a number of memory locations. The core operating system is arranged to create a number of protection domains to partition the system space into a core operating system space in a system protection domain and a plurality of partitions in a corresponding plurality of partition protection domains. One or more data buffers are provided in the system protection domain. In addition, an interpartition communication system is provided for transmitting a message from a source partition of the plurality of partitions to one or more destination partitions of the plurality of partitions. The interpartition communication system includes a sender process in each source partition protection domain and a receiver process in each destination partition protection domain. The sender process in each source partition protection domain is executable to deliver messages for one or more destination partitions to one or more of the one or more data buffers, and the receiver process in each destination partition protection domain is executable to retrieve messages, for which its respective partition is one of the destination partitions, from one or more of the one or more data buffers.

In accordance with further embodiments of the present invention, computer readable media are provided, having stored thereon, computer executable process steps operable to control a computer to implement the embodiments described above.

### BRIEF DESCRIPTION OF THE DRAWINGS

FIG. 1 shows a block diagram of an exemplary computer system implementing a two-level operating system architecture according to the present invention.

FIG. 2 shows an exemplary system space of the computer system of FIG. 1.

FIG. 3 shows the system space of FIG. 2 arranged into partitions according to an exemplary embodiment of the two-level operating system architecture according to the present invention.

FIG. 4 shows a logical block diagram of an exemplary protection domain implemented in the system space of FIG. 3.

FIG. 5 shows an exemplary protection view data structure from the protection domain of FIG. 4.

FIG. 6 shows a graphical representation of a time-multiplexed partition scheduling arrangement according to the present invention.

FIG. 7 is illustrates a channel including one sending port and two receiving ports.

FIG. 8 illustrates one embodiment of the present invention for implementing a SENDER_BLOCK protocol for queuing mode ports.

FIG. 9 illustrates another embodiment of the present invention for implementing a sender blocking protocol and a full discard protocol.

FIG. 10 is an illustrative flow chart for implementing a sender blocking protocol with the port structure of FIG. 9.

FIG. 11 illustrates a sampling mode port in accordance with another embodiment of the present invention.

### DETAILED DESCRIPTION OF THE PREFERRED EMBODIMENTS

In accordance with an embodiment of the present invention, a computer system and method for operating a computer is provided. The computer system includes a core operating system and a system space having a number of memory locations. The core operating system is arranged to create a number of partitions in the system space. Preferably, the partitions are implemented as protection domains and the core operating system space is also in a protection domain. A partition operating system and a partition user application are provided in each partition, and each partition operating system provides resource allocation services to the respective partition user application within the partition.

The system also includes an interpartition communication system that interacts with the core operating system and each partition operating system to deliver messages between partitions. Preferably, the interpartition communication system includes channels, source ports, and destination ports. In such a system, each channel includes one source port and one or more destination ports. Messages sent from a source port are delivered to each destination port in that source port's channel. Preferably, each port (source or destination) is associated with only one channel. To support bidirectional interpartition communication, each partition includes at least one source port (for sending messages) and at least one destination port (for receiving messages). However, a partition can also include a plurality of source ports and/or a plurality of destination ports. Moreover, a partition that wishes to support uni-directional communication may include only a source port, or only a destination port, and a partition that does not wish to support any interpartition communication may include no ports.

A variety of protocols can be used in connection with the interpartition communication system. For example, the system can support a “sampling” protocol, in which each new message placed in a source port or a destination port overwrites the previous message in the port. Alternatively, the system can support a “queuing” protocol, wherein messages are not overwritten. Rather, messages in a source port remain there until sent, and messages in a destination port remain there until read. In the queuing protocol, the source and destination ports each preferably hold a plurality of messages. Most preferably, the number of messages that can be maintained in a port is configurable on a port by port basis. Preferably, the system supports both protocols, and the ports of each channel can be configured in a “queuing” mode or a “sampling” mode.

Preferably, the “queuing” protocol includes one or both of two further protocols: sender blocking and full discard. With the sender blocking protocol, if one of the destination ports of a channel is full, the source port does not send the message to any of the destination ports. In contrast, with the full discard protocol, if one of the destination ports of a channel is full, the source port sends the message to each destination port of the channel except the destination port that was full.

The channels, ports, and protocols described above can be implemented in a variety of ways. For example, the source ports and destination ports can be implemented as data buffers within the protection domain of their respective partitions, with transfer between source and destination ports implemented via a driver in the core operating system space. Alternatively, the source ports and destination ports can be implemented as data buffers within the core operating system space.

In one embodiment employing data buffers in the core operating system space for a queuing protocol, data buffer(s) are provided in the core operating system space. A sender process and a receiver process are provided in each partition. In each partition, the sender process is executable to deliver messages destined for another partition(s) (e.g., via a channel having a destination port associated with the destination partition) to the data buffer. Similarly, the receiver process in each partition is executable to retrieve messages for that partition from the data buffer. The delivery and retrieval can be implemented via a system call, as described in more detail below.

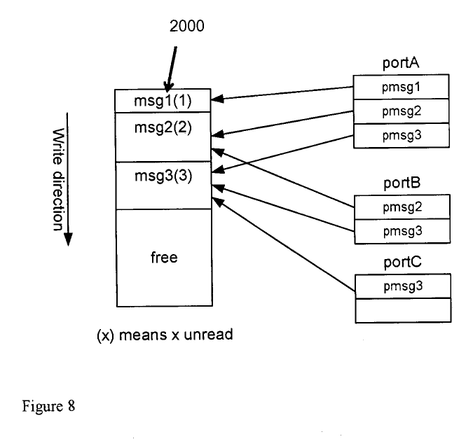

In certain embodiments a single data buffer is used for each channel. In this regard, messages are delivered into a single data buffer that has a size equal to the size of the largest destination port in the channel. The receive process in each destination partition reads the data from the single data buffer (e.g., via a system call). The system tracks (e.g., via a counter) the number of times each message in the buffer is read. When the number of “reads” equals the number of destination ports, the message can be overwritten. Such a system is described in more detail below in connection with FIG. 8.

In other embodiments, separate data buffers are provided in the core operating system space for the source and destination ports, and a port driver is provided in the core operating system space for transferring messages from the data buffer for a source port (the source buffer) to the data buffer for each destination port (the destination buffers). In such an architecture, data could be transferred as follows. A sender process in a partition is executable to deliver a messages to a source buffer in the core operating system space that corresponds to a desired channel. This delivery is implemented utilizing its partition operating system and the core operating system (e.g., via a system call). The port driver in the core operating system space is executable to transfer the messages from the source buffer to each destination buffer in the channel. Each destination buffer, in turn, is associated with one of the destination partitions of the message. In each destination partition, a receiver process is executable to retrieve messages from its corresponding destination buffer utilizing its partition operating system and the core operating system (e.g., via a system call).

In accordance with certain further embodiments of the present invention, each sender process maintains information indicative of an available memory space in its corresponding source buffer, and the sender process only delivers a message to its corresponding source buffer if said information indicates that said available memory space is sufficient to store the message.

In accordance with a still further embodiment of the present invention, when the port driver transfers a message out of one of the source buffers, the port driver notifies the partition operating system for the partition corresponding said one source buffer, and, based upon said notification, the corresponding sender process updates said information.

As one of ordinary skill in the art will appreciate, the data buffer implementations described above could also be used to implement a sampling protocol. However, since the sampling protocol does not allow messages to be queued, many of the features of the above embodiments are unnecessary.

In accordance with another embodiment of the present invention, an alternative implementation of a sampling mode protocol is provided. A pair of data buffers are provided in the core operating system space for each channel. Each data buffer need only hold one message. Preferably, sampling protocol messages have a fixed length. Each buffer has a status: “temporary” or “valid”. When a sender process wishes to send a message to the channel, it writes the message into the one of the two buffers which has the “temporary” status. After it completes the delivery (e.g., via a system call), it changes the status of the “temporary” buffer to “valid”. The status of the other buffer is changed to “temporary.” In each destination partition for the channel, the receiver process reads the message from the “valid” buffer using, for example, a system call.

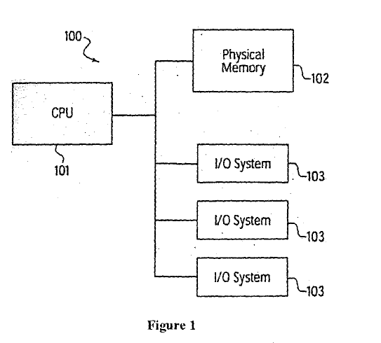

Referring now to the drawings, and initially to FIG. 1, there is illustrated in block diagram form, a computer system 100 comprising a CPU 101, which is coupled to a physical memory system 102 and a number of I/O systems 103. Connection of the CPU 101 to the physical memory system 102 and the number of I/O systems 103 may be according to any of the well known system architectures (e.g., PCI bus) and may include additional systems in order to achieve connectivity. I/O systems 103 may comprise any of the well known input or output systems used in electronic devices (e.g., key pad, display, pointing device, modem, network connection). Physical memory system 102 may include RAM or other memory storage systems, and read only memory and/or other non-volatile storage systems for storage of software (an operating system, other applications) to be executed in the computer system 100. Alternately, software may be stored externally of computer system 100 and accessed from one of the I/O systems 103 (e.g., via a network connection). CPU 101 may also include a memory management unit (MMU, not shown) for implementing virtual memory mapping, caching, privilege checking and other memory management functions, as is also well known.

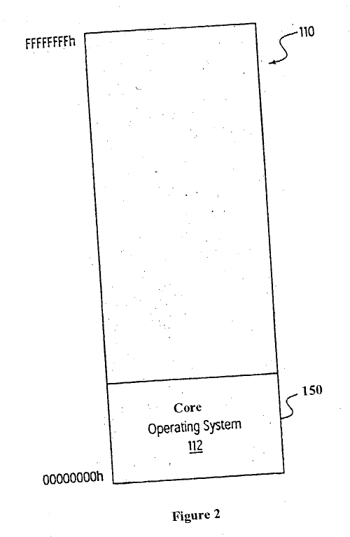

FIG. 2 illustrates an exemplary system space 110 of the computer system 100. System space 110 is, for example, an addressable virtual memory space available in the computer system 100. The system space 110 may be equal to or greater than the memory capacity of the physical memory 102 of the computer system 100, depending on system memory management implementations, as are well known. System space 110 may also include memory locations assigned as “memory mapped I/O” locations, allowing I/O operations through the system space 110. As shown in FIG. 2, the system space 110 includes addressable locations from 00000000h (hexadecimal) to FFFFFFFFh, defining a 32-bit addressable space. In this example, the system space 110 is implemented as a “flat” address space: each address corresponds to a unique virtual memory location for all objects in the system space 110 regardless of the object's owner. Other known addressing methods may also be used.

According to the present invention, the system space 110 stores a core operating system 112, such as, for example the VxWorksAE operating system. The core operating system 112 includes executable code and data structures, as well as a number executing tasks and system objects that perform system control functions, as will be described in more detail below. Pursuant to the present invention, the core operating system 112 implements a protection domain system in which all resources and objects are contained within protection domains. The core operating system itself can be contained in a protection domain 150. The exemplary protection domain system of the core operating system 112 is also object oriented, and each protection domain is a system object.

By way of background, operating systems implemented in an “object oriented” manner are designed such that when a particular function and/or data structure (defined by a “class” definition) is requested, the operating system creates (“instantiates”) an “object” that uses executable code and/or data structure definitions specified in the class definition. Such objects thus may contain executable code, data structures, or both. Objects that perform actions are typically referred to as “tasks” or “processes” (which may include tasks or threads)—they may all be referred to generally as executable entities, but will be referred to herein simply as tasks for purposes of clarity. Upon loading and execution of an operating system into the computing environment, system tasks and processes will be created in order to support the resource allocation needs of the system. User applications likewise upon execution may cause the creation of tasks (“user tasks”) and other objects in order to perform the actions desired from the application.

The structure of each protection domain is defined through a protection domain “class” definition. A protection domain may be created, for example, by instantiating a protection domain object based on the protection domain class. Only the core operating system 112 can create or modify (or destroy) a protection domain, although user tasks can request such actions through a protection domain application programming interface (API) provided by the core operating system. A protection domain object is owned by the protection domain that requested its creation.

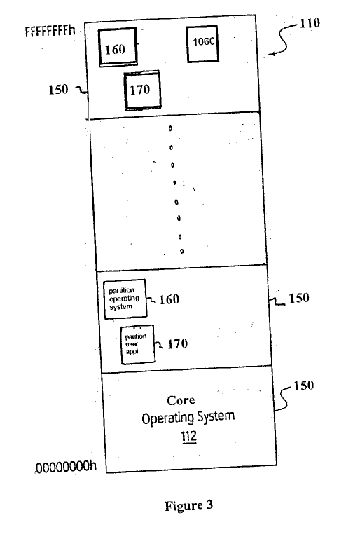

Referring now to FIG. 3, there is illustrated the system space 110 of FIG. 2 arranged into partitions according to an exemplary embodiment of the two-level operating system architecture according to the present invention. The core operating system 112 instantiates a number of protection domains 150 to provide partitions within the memory system space 110, as will be described in more detail below. Instantiated within each partition defined by a protection domain 150 is a partition operating system 160 and a partition user application 170. According to this exemplary embodiment of the present invention, each partition operating system 160 is dedicated to the respective partition user application 170 within the same protection domain 150, and the partition user application 170 interacts with the respective partition operating system 160. The partition operating system 160 allocates resources instantiated within the protection domain 150 to the respective partition user application 170. As discussed, each of the partition operating system 160 and the respective partition user application 170 of a particular protection domain-defined partition comprises objects including executable code and/or data structures. All of such objects are instantiated in the respective protection domain of the partition. The term “user application” is used herein to denote one or more user applications instantiated within a particular protection domain.

In this manner, user applications can be spatially separated into discrete partitions of the system space 110 so that they are unable to interact with each other, except through explicit mechanisms, as for example, under tight control of the two-level operating system architecture implementing the protection domain scheme. Moreover, each user application 170 can be controlled through explicit allocation of resources owned by the protection domain, by the partition operating system 160, to prevent the applications from affecting the operation of the entire system.

Pursuant to the exemplary embodiment of the present invention, the core operating system 112 performs certain functions for the overall system and/or on behalf of each partition operating system 160. As discussed, the core operating system 112 creates and enforces partition boundaries by instantiation of the protection domains 150. The core operating system 112 schedules partition processor usage among the several protection-domain-defined partitions, to determine which user application and respective partition operating system will be operating at any given time. In addition, the core operating system 112 can control system resource allocation, the passing of messages between the partitions, the handling of interrupts, the trapping of exceptions and the execution of system calls, on behalf of the partition operating systems 160, and the Input/Output systems 103.

Each of the partition operating systems 160 can be implemented from object components of a real time operating system such as, for example, VxWorks®, marketed by Wind River Systems of Alameda, California. The components can include, for example, kernel, math, stdio, libc and I/O functionality of the VxWorks® real time operating system to achieve resource allocation for user task management and inter-task communication for the respective partition user application 170. Each partition operating system 160 is also implemented to support user-application level context switches within a partition, and to indirectly interact with I/O devices via calls to the core operating system 112. Each partition operating system 160 can also be configured to call the core operating system 112 for access to resources maintained at the system level, and for the handling of traps and exceptions by the core operating system 112. Accordingly, the partition operating system 160 appears to be the only operating system to user application 170, and thus user application 170 can be implemented in a standard manner, without consideration of the interface or operation of core operating system 112.

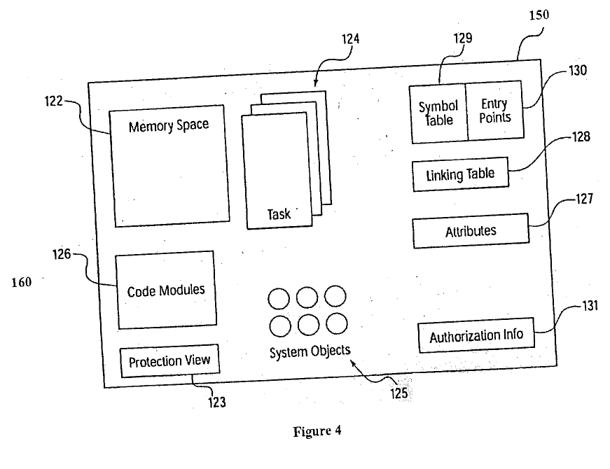

Referring now to FIG. 4, there is illustrated a logical block diagram of an exemplary protection domain 150, as may be created by the core operating system 112. The specific components capable of being “owned” by a protection domain 150 may be specified in the protection domain class definition. Exemplary protection domain 150 may be considered the owner of one or more of the following components:

1) a memory space 122,

2) a protection view 123,

3) zero or more code modules 126 containing executable code and/or data structures of, for example, the partition operating system and partition user application,

4) a collection of protection domain “attributes” 127,

5) a linking table 128 and a symbol table 129 including a list of entry points 130, zero or more tasks 124, and

6) zero or more system objects 125 (e.g., semaphores, file descriptors, message queues, watchdogs).

Memory space 122 comprises a number of virtual memory locations from system space 110. These memory locations need not be contiguous, and may include memory mapped I/O locations. The amount of memory allocated to the memory space 122 of a protection domain 150 by the core operating system 112 may be specified at the time protection domain 150 is created. Additional memory may be dynamically allocated to memory space 122 by the core operating system 112 as needed from any free memory in system space 110. The code modules are stored within the memory space 122.

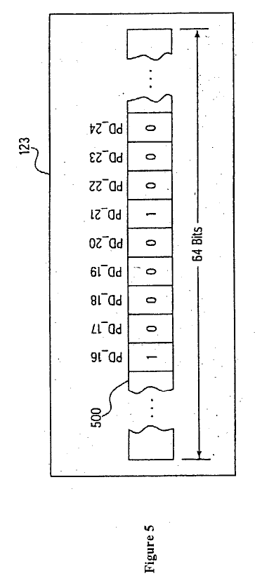

Upon creation of the protection domain 150, the protection view 123 is established. The protection view 123 represents all of the protection domains 150 to which tasks executing in the protection domain 150 illustrated in FIG. 4 may have access. An exemplary protection view data structure 500 that may be used to represent the protection view 123 is illustrated in FIG. 5.

Protection view data structure 500 is a bit map for a particular protection domain 150, in which each protection domain 150 in the system space 110 is represented by a single bit. Where a bit is set, the respective protection domain 150 represented by the bit map has unprotected access to the memory space 122 of the corresponding protection domain in system space 110. Where a bit is not set, unprotected access is not permitted. The core operating system 112 may maintain information for mapping each bit to an existing protection domain 150. The size of the bit map defines the maximum number of protection domains supported in the system space 110; in this example, sixty-four protection domains are possible. Note that other data structures or different sized bit maps could be used to represent the protection view 123 to increase or decrease the number of protection domains that can be in a protection view. The default condition for a specific protection domain 150 is a protection view 123 that includes only the resources and objects of the memory space 122 of that protection domain 150, and no other protection domains. In the exemplary bit map of protection view data structure 500, this default condition may be represented by setting the bit corresponding to the illustrated protection domain, while leaving the remaining bits cleared (value zero). A protection domain 150 may expand its protection view 123 by being “attached” to other protection domains during the linking process when code modules or other objects are loaded into protection domain 150, pursuant to features of the VxWorksAE operating system.

Also upon creation of a protection domain 150 by the core operating system 112, a set of protection domain attributes 127 may be specified. These attributes may be used to control the actions allowed by tasks executing in the created protection domain 150, the linking permitted between the created protection domain 150 and other protection domains in the system space 110, and other characteristics of the protection domain 150. Among the protection domain attributes 127 supported by protection domains 150 of, for example, the VxWorksAE operating system are:

1) the name of the protection domain

2) the maximum memory size of the protection domain

3) whether the protection domain may be linked to by code modules in other protection domains (“linkage control”)

4) the processor privilege mode that may be assigned to tasks created (“spawned”) in the protection domain (e.g., user/supervisor).

Other attributes may also be used, depending on the specific implementation of the protection domain system.

In addition, during the protection domain creation process by the core operating system 112, the memory space 122 is loaded with code modules 126. Pursuant to certain embodiments of the present invention, the code modules 126 include the partition operating system 160 of the respective partition 150, and the respective user application 170. The code modules 126 comprising the partition operating system 160 and the respective partition user application 170 are therefore spatially separated from other code modules of system space 110 by a protection domain-defined partition. Thus, execution of user tasks, and resource allocation control functions of a the partition operating system for the specific tasks, can be accomplished from within a protected and separated portion of the system space 110. Such an arrangement minimizes the ability of a user application form affecting anything within the system space that is beyond its partition.

For maximum security, the protection view of a partition 150 can be set in the default mode wherein only objects within the specific protection domain memory space 122 can be accessed by executable code executing within the partition 150. Thus, each partition operating system and partition user application pair can be substantially spatially isolated from all other system space.

However, the executable code may include a number of instructions, which, for example, in the case of a code module of the respective partition user application 170, reference other executable code or data structures outside of code module 126 (e.g., via a “jump” or “branch” instruction to execute a function). These references may be made using “symbols” that are intended to represent the memory location of the desired code or data structure. In order to determine (“resolve”) the memory address value of these symbols, the loading of code modules 126 may include a linking process of the type provided in the VxWorksAE operating system, that attempts to resolve symbol references by searching for other occurrences of the symbol either in other code modules 126 already loaded into the respective protection domain 150, or in code modules loaded into other protection domains.

As illustrated in FIG. 4, a symbol table 129, with entry points 130, and a linking table 128, are provided. These tables are features of the VxWorksAE operating system that can be used to achieve protected links between executable code in one protection domain 150 and resources of another protection domain, if desired.

Pursuant to a feature of the exemplary embodiment of the present invention, the core operating system 112 schedules partition operation to determine which partition operating system, partition user application pair is to execute at any particular time. The core operating system implements temporal partitions, preferably using a time-multiplexed schedule, between the partition operating system, partition user application pairs of the protection domain-defined spatial partitions 150.

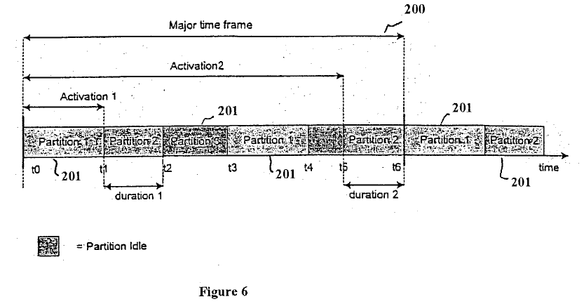

A preferred time-multiplexed schedule is illustrated in FIG. 6. A timing sequence comprises a series of major time frames 200. The major time frames 200 are repetitive, and each major time frame 200 has a predetermined, fixed periodicity. In this manner, the major time frames 200 are deterministic. The basic scheduling unit of the major time frame 200 is a temporal partition 201, and there is no priority among the temporal partitions 201.

Alternative schemes for providing temporal partitions could also be used. For example, a priority based scheme could be used wherein the partition with the highest priority task (or other operation) is scheduled for a specified duration.

Returning to the time-multiplexed schedule of FIG. 6, at least one temporal partition 201 is allocated to each protection domain-defined spatial partition 150, and a protection domain-defined partition 150 is activated by allocation of at least one temporal partition 201 from within the major time frame 200 to the particular partition 150. Each temporal partition 201 has two attributes, an activation time within the major time frame 200 (in FIG. 6, indicated by “t0” to “t6”), and an expected duration (in FIG. 6, indicated by duration 1, duration 2). Each temporal partition is defined by an offset from the start of a major time frame 200 (the activation time) and its expected duration. The duration of each temporal partition is set in fixed increments. The value of the increments can be configurable. As shown in FIG. 6, not all of the time available in a major time frame 200 may be scheduled to partitions. Such unscheduled time may be used by core operating system 112 for system operations or may simply be idle time.

In accordance with one preferred embodiment of the present invention, time management within a partition is accomplished through maintenance of a single timer queue. This queue is used for the management of watchdog timers, and timeouts on various operations.

Elements on the queue are advanced when a system clock “tick” is announced to the partition operating system. Each tick denotes the passage of a single unit of time. Ticks are announced to the partition operating system from the core operating system through a “pseudo-interrupt” mechanism (e.g., via a system clock tick event). During initialization of the partition operating system, the current tick count maintained by the partition operating system will be set to equal the value of the core operating system tick count (as a result, the tick count of each partition will be synchronized with each other and the core operating system). Preferably, there are no limits on the clock tick rate that can be accommodated by the partition operating system, other than the available processor cycles that can be utilized by the system in servicing clock hardware interrupts and issuing pseudo-interrupts.

Preferably, clock ticks are only delivered to a partition during that partition's window of execution (e.g., via a system clock tick event). When the core operating system schedules in a new partition, the clock ticks are then delivered to the newly scheduled partition. The issuance of clock ticks to the scheduled-out partition recommences at the start of the partition's next window. At this point, the core operating system announces, in batch mode (e.g., with a single pseudo interrupt), all the clock ticks that have transpired since the last tick announced to the partition in its previous window. In such a system, a timeout (or delay) can expire outside the partition's window, but the timeout is only acted upon at the beginning of the next partition window. It should be appreciated, however, that if a particular time out (or delay) is critical, the system integrator could simply increase the duration of temporal partition 201 for the corresponding spatial partition 150, or provide that a plurality of temporal partitions 201 be assigned to the spatial partition.

The batch delivery of clock ticks allows the core operating system to conserve processor cycles. Although the core operating system is still required to service the clock hardware interrupts, processor cycles are conserved by elimination of the overhead involved in issuing pseudo-interrupts, and the subsequent processing of the ticks within the various partition operating systems. This is particularly true for systems that require a timeout specification granularity of 0.25 milliseconds (which translates into 4000 ticks per second).

Scheduling of tasks within a partition can be implemented in a number of ways. For example, tasks within a partition may be scheduled using a priority scheme. In a preferred embodiment of the present invention, the priority scheme is implemented in accordance with a pre-emptive priority-based algorithm. In such an embodiment, each task has an assigned priority, and in each partition, the partition operating system scheduler uses the priority assigned to each task to allocate the CPU to the highest-priority task within the partition that is ready to execute.

In a pre-emption based scheme, pre-emption occurs when a task of higher priority than the currently executing task becomes ready to run. In general, a higher-priority task may become ready to run as a result of the expiration of a timeout, or the new availability of a resource that the task had been pending on. Pre-emptive events are delivered from the core operating system to the partition operating system, through the pseudo-interrupt mechanism. These events, which may result in a higher priority task becoming available, include but are not limited to, the system clock tick and the system call completed signals (discussed below).

The scheduling of equal priority tasks can be implemented in a number of ways. For example, equal priority tasks can be scheduled on a first-come-first serve basis (e.g., using a queue of equal priority tasks). Alternatively, round-robin scheduling could be used. Preferably, the system allows the system integrator to select either round-robin scheduling or first-come-first-serve scheduling. Round-robin scheduling allows the processor to be shared by all tasks of the same priority. Without round-robin scheduling, when multiple tasks of equal priority must share the processor, a single non-blocking task can usurp the processor until pre-empted by a task of higher priority, thus never giving the other equal-priority tasks a chance to run. In accordance with round-robin scheduling, a “time slice” (or interval) is defined which represents the maximum time that a task is allowed to run before relinquishing control to another task of equal priority. Preferably, the “time slice” is a variable that can be set by calling an appropriate routine.

When a partition operating system 160, or an application running in a partition operating system 160, needs to request a service from the core operating system, a system call is issued from the partition operating system to the core operating system. If the system call is a blocking system call, then the core operating system assigns a worker task 1060 (which is a core operating system task executing in a partition as illustrated in FIG. 3) to complete the request, and returns control to the partition operating system. The partition operating system then pends the requesting task, and schedules the next highest priority task that is ready to run. When the assigned core operating system task completes the system call, a system-call-complete pseudo interrupt is issued by the core operating system to the partition operating system. After receiving the system-call-complete, the partition operating system places the task in the “ready” queue (i.e., it makes the task ready to run, but does not deschedule the current task). Alternatively, the system could be designed such that, upon receiving the system call complete, the partition operating system pends the currently executing task and schedules the requesting task. An exemplary implementation of this functionality is described in more detail in related U.S. application Ser. No. ______ [218.1045] referenced above.

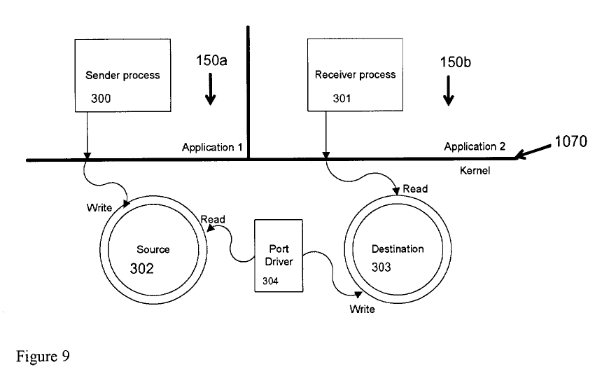

Each partition operating system is preferably implemented as an executable entity on top of the core operating system. In a preferred embodiment of the present invention, the partition operating system operation does not depend on the details of the core operating system. Rather, the partition operating system simply needs a specific set of services to be provided by the core operating system, particularly services related to the underlying system hardware (e.g., I/O operations, interrupts, exceptions). To provide this level of functionality, an abstraction layer 1070 (see FIG. 9) is preferably interposed between the partition operating systems and the core operating system.

Preferably, abstraction layer 1070 is a thin layer of code that abstracts the specifics of the underlying core operating system so allowing the partition operating systems to run. In order to provide sufficient separation among the core operating system and the various partitions, it is advantageous to limit the number, and nature, of communication between the core operating system and each partition operating system. This architecture allows the core operating system to be used with multiple types of partition operating systems (perhaps in the same overall system), and allows the partition operating system to run on more than one type of core operating system, with minimal changes. A particularly preferred embodiment of the abstraction layer will now be described, wherein the communication between the partition operating systems and the core operating system is limited to:

1. System Calls (from a partition operating system to the core operating system)

2. Pseudo-Interrupts (from the core operating system to a partition operating system)

In this embodiment, abstraction layer functionality resides in both the core operating system and each partition operating system. Each half of the abstraction layer understands the requirements and data format expected by the other half.

System calls are initiated by the partition operating system to request the core operating system to perform a desired service. In this example, there is only one system call API defined by the abstraction layer, which can multiplex all service requests. The partition operating system can request a core operating system service by issuing the system call (e.g., vThreadsOsInvoke( ), for purposes of illustration). This system call causes the portion of the abstraction layer in the partition operating system to issue a system call proper (e.g., valOsInvoke( ), for purposes of illustration) to the portion of the abstraction layer in the core operating system. In the core operating system portion of the abstraction layer, the system call proper is converted into an appropriate core operating system API call which performs the desired service(s). Preferably, the set of system services (methods) that the partition operating system is allowed to request is limited.

Preferably, all service requests from the partition operating system are invoked via the single system call (vThreadsOSInvoke( )). Upon receiving the system function call, the partition operating system portion of the abstraction layer issues the system call proper (valOsInvoke( )) as described above. The arguments of valOsInvoke( ) specify the service requested along with any additional parameters. The core operating system portion of the abstraction layer performs parameter validation on all system call arguments before invoking core operating system API functions.

An exemplary nomenclature for the valOsInvoke( ) function could be:

| OS_INVOKE_STATUS valOsInvoke | |
|---|---|
| ( | |
| SYSCALL_METHOD | method, |
| UINT32 | *returnValue, |
| UINT32 | *methodErrno, |
| UINT32 | cookie, |
| UINT32 | argument 1, |
| ... | |
| UINT32 | argument n |
| ); | |

wherein UINT32 is an unsigned integer.

In this example, the arguments given to valOsInvoke( ) are defined as follows:

method: An enumeration that specifies the core operating system service to be invoked.

returnValue: A pointer to an unsigned integer, which is de-referenced to store the return value from the system call.

methodErrno: A pointer to an unsigned integer, which is de-referenced to store the error number value (if any) set by the system call.

Cookie: A value that is unique to the requesting partition. Typically it is the ID of the partition operating system task that issued the request. This value has no significance to the core operating system. When the system call completes, the cookie is returned back to the requesting partition, and assists the partition operating system in identifying the task whose request has been completed.

argument1-n: The argument(s) that is passed to the core operating system function being invoked. There may be zero or more arguments to a system call, depending on the service requested.

OS_INVOKE_STATUS: Enumerated result code of the call. Can be one of OK, ERROR, PENDING, OSNOTREADY, or BADPARAMS

The actual invocation of core operating system services depends on the mechanism that is used by it (e.g. the Linkage Table method for VxWorks AE, or a UNIX-style system call invocation). Only the core operating system portion of the abstraction layer need know the details of how core operating system services are invoked. An exemplary implementation of the abstraction layer functionality is described in more detail in related U.S. application Ser. No. ______ [218.1045] referenced above.

As noted above, pseudo-interrupts may be used, inter alia, to provide asynchronous event notification/information (including clock tick and service call complete events) to the partition operating system (as contrasted with a tradition hardware interrupt/exception). A preferred implementation of the pseudo interrupts will now be described in more detail. In accordance with this implementation, each partition has a corresponding event queue in the system protection domain. This event queue may, for example, be organized as an array of event structures. The core operating system follows a two-step process in delivering a pseudo-interrupt to a partition operating system: first, an event is placed in the queue, and then, a signal is sent to the receiving partition operating system. An exemplary set of events is as follows:

1. “Power Interruption”

2. “Synchronize”: used by the core operating system to detect whether the specified partition operating system is executing a critical code section, such that access of operating system data structure may produce inaccurate results. Useful for interactions with development tools

3. “System Clock Tick”: reports the occurrence of a “tick” of the system clock, allowing each partition operating system to receive synchronized time information.

4. “Port Receive Notification”: indicates that a message has been received at a destination buffer 303 (see FIG. 9, and accompanying discussion).

5. “Port Send Notification”: indicates that a message in a source buffer 302 has been sent (see FIG. 9, and accompanying discussion).

6. “System Call Complete”: reports the completion of a previously requested system call to the core operating system that was dispatched to a worker task.

It should be noted, however, that synchronous exceptions are not queued in this implementation. Rather, the core operating system re-vectors the program flow of the partition's code by directly changing the program counter (pc) to execute the partition's synchronous exception handler. An exemplary implementation of the pseudo interrupts are described in more detail in related U.S. application Ser. No. ______ [218.1045] referenced above.

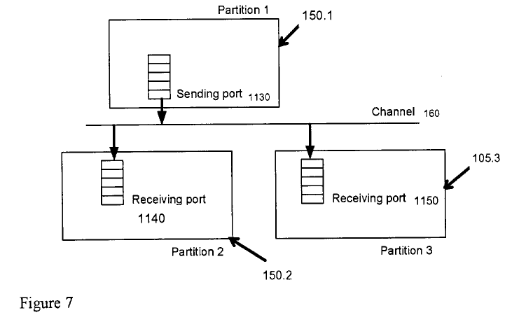

Pursuant to another feature of the present invention, a communication system is provided to permit the passing of messages between partitions 150. FIG. 7 shows a schematic diagram of an illustrative inter-partition communication system 1000. In this regard, the inter-partition communication encompasses all communication between two or more partitions, for example a first, second and third partition 150.1, 150.2, 150.3.

The communication between the partitions 150.1, 150.2, 150.3 is defined via messages and ports, for example, a first, second, and third port 1130,1140,1150. In FIG. 7, the first port 1130 is a sending port, and the second and third ports 1140,1150 are receiving ports. A message can be sent from a single source (e.g. sending port 1130) to one or multiple destination ports (e.g., receiving ports 1140, 1150). Each of ports 1130, 1140, 1150 may be physically located within their respective partitions or may be located outside their partitions with access provided thereto by various mechanisms, as will be described below.

A channel 160 is defined as a set of logically associated ports. Preferably, one of the ports of the channel is a source (i.e., send or sending) port and the remaining ports are destination (i.e., receive or receiving) ports. The constituent ports, per se, define the channel.

Each partition which desires bidirectional communication with other partitions includes at least one source port and at least one destination port. A partition that does not need to communicate with other partitions can include zero ports, and a partition that needs to provide only one way communication could potentially include only one port.

Table 1 shows an exemplary definition of five ports and two associated channels.

TABLE 1

| | | Direc- | | | | |
|---|---|---|---|---|---|---|
| Name | Partition | tion | Size | Mode | Sender | Rate |
| Sender_1 | Partition_1 | Send | 560 | Queuing | | |
| Recv_1 | Partition_2 | Receive | 560 | Queuing | Sender_1 | |
| Recv_2 | Partition_3 | Receive | 560 | Queuing | Sender_1 | |
| Pressure | Partition_1 | Send | 20 | Sampling | | |
| Recv3 | Partition_3 | Receive | 20 | Sampling | Pressure | 50 |

In Table 1 above, “name” refers to the name of the port, “partition” refers to the partition that the port is associated with, “direction” indicates whether the port is a “send” port or a “receive” port, “size” refers to the size of the port, “mode” indicates whether the mode of the port is “queuing” or “sampling” (described below), “sender” indicates, for each “receive” port, the name of the “send” port, and “rate” refers to the refresh rate of the port. It should be noted that assuming that the system is not configured to truncate messages, the size of the send port should be no larger than the size of the smallest receive port. Preferably, the definition is checked at initialization to ensure that no channel has a send port which has a size that is larger than any of its receive ports.

Preferably, ports are defined by a set of unique attributes. An exemplary set of attributes is shown in Table 2:

TABLE 2

| Attribute | Type | Comment |
|---|---|---|
| Partition identifier | ASCII string | |
| Port name | ASCII string | |
| Mode of transfer | Sampling/queuing | |
| Transfer direction | Source/destination | |
| Message segment | Size | Optional |
| length | | |
| Message storage | Size | Size of storage area for message |
| requirements | | buffering |
| Required refresh | Time | |
| rate | | |
| Mapping | Enum | Optional |
| requirement | | |
| Messaging | Discard/Block | See below |
| protocol | | |

Preferably, the configuration of the system is defined at build time and is expressed in the system configuration tables.

As mentioned above, the interpartition communication system preferably implements both a sampling mode and a queuing mode. Most preferably, each channel can be configured as either a sampling mode channel or a queuing mode channel. Alternatively, the system may be configured to use only one mode or the other.

In sampling mode, messages carry similar but updated data. The message remains in the source port until is transmitted or overwritten. Instances of the message must arrive in the order in which they were sent. Each new instance of the message overwrites the previous message when it reaches the destination port. The message remains in the destination port until it is overwritten by the next message. Sampling mode messages are preferably of a fixed length. If fixed length messages are not employed, functionality may be provided to ensure message integrity (e.g., to ensure that the system is aware of the length of each message).

In queuing mode, messages are queued, each message contains different data, and overwriting is not allowed. Messages are stored in the source port queue until transmission, and then stored in the destination port queue until the application reads them. A variety of protocols can be used to manage the message queues, several of which will be described in more detail below.

Preferably, the interpartition messaging system utilizes a parameter to define a maximum number of messages for each port. This parameter is preferably defined on a port by port basis, but could alternatively be set as a global parameter. An alternative to this parameter would be to define the size of the port, without regard to the number of messages. Although such a scheme can be used, it has certain disadvantages. Specifically, in a worst-case scenario, a port of size N could buffer N messages of size 1 byte. Since message handling requires a header for each message, it would be necessary to allocate more memory than the buffer area itself. Allocating sufficient memory for the worst case may be unacceptable in systems with limited resources. Therefore, the system preferably uses a parameter (e.g., N) that limits the number (e.g., assigns a maximum) of messages that can be sent to a queue.

Preferably, a number of parameters that have system-wide effect are defined as configuration parameters in a project tool so that no operating system library needs to be recompiled if a parameter is changed. Preferably, the following system-wide parameters are defined in this manner: the maximum number of sampling ports in a system, the maximum number of queuing ports in a system, the maximum size of a sampling message, the maximum size of a queuing message, the maximum size of a sampling port, and the maximum size of a queuing port.

A preferred protocol for the queuing mode allows selection of one of a sender blocking protocol (specified by a SENDER_BLOCK attribute) and a full discard protocol (specified by a FULL_DISCARD attribute). The selected protocol can be implemented as an attribute of each destination port. However, as a single destination port with a ‘SENDER_BLOCK’ attribute can (for reasons set forth below) block an entire channel, it is preferable to have the attribute set as a channel-wide attribute attached to the source port of the channel.

In accordance with the sender blocking protocol, a queued message (i.e., a message in a send port) is sent to all destination ports or none. If one of the destination ports is full, the message remains in the send port. If the send port becomes full, the sending process which writes to the send port (e.g., through a call to SEND_QUEUING_MESSAGE for purposes of illustration) is blocked until the send port becomes available. After a full destination port becomes available, re-transmission is tried. However, this retransmission may or may not succeed, depending upon whether any of the other destination ports in the channel are full. An advantage of the sender blocking protocol is that no messages are lost. A drawback of this protocol is that a non-responsive partition (e.g. a disabled partition or a partition which cannot, for some reason, clear its destination port) will block the whole channel affecting the normal behavior of the receive ports in other receiving partitions.

In accordance with the full discard protocol, a queued message is sent to all destination ports in the channel. If one of the destination ports is full, the message is discarded and does not reach that destination port. However, the message will be received at each other destination port in the channel that is not full. The send port does not attempt to queue the message in the send port. If all destination queues are full, the message is discarded. When using the full discard protocol, no coupling is introduced between partitions and a non-responsive partition will not prevent delivery of messages to other partitions.

The send and receives ports can be implemented in a number of ways. For example, the ports could be provided in the partitions, using a driver for transfers to other partitions. Alternatively, the ports could be provided in a shared memory area with direct access by partitions. Another option is to place the ports are in a shared memory area, with access provided with a driver.

Placing the ports in the partition space offers the advantage of fast access to the ports and the messages stored therein. In such an embodiment, a driver could be located in the core operating system protection domain for copying data from one partition to another. To inform the core operating system 112 about the new messages in a send port, a system call could be transmitted from send port's partition to the core operating system (for example, using abstraction layer 1070). The driver in the core operating system could then copy the data to all receiving partitions (e.g., using memory context switches).

In a first embodiment using a shared memory for port data, direct access is allowed to the port data by the sender and receiver partitions, and data integrity can be preserved through parameter control when accessing the shared memory (e.g., the application uses the safe kernel code to access the data). A robust synchronization and exclusion mechanism could be used to allow simultaneous access to the data. Strict exclusion could be achieved by locking scheduling. This would lessen (or remove) reentrancy issues.

In a second embodiment using shared memory for port data, access to the shared memory is provided with a driver. In this embodiment the port memory is accessed by the sender and receiver partition though a system call to the core operating system. A port driver residing in the core operating system is used to transfer data from senders to receivers. With this solution, there is no need for any additional synchronization or exclusion mechanism. This embodiment will now be described in further detail.

FIG. 8 illustrates an embodiment which uses common memory buffer 2000 for storing all of the messages received in the sender blocking protocol. A sender process in a partition delivers messages into the memory buffer 2000 via a system call. The receive process in each destination partition reads the data from the memory buffer (e.g., via a system call). The system tracks the number of times each message in the buffer is read (e.g., by incrementing a message counter variable). When the number of “reads” equals the number of destination ports, the message can be overwritten. The memory buffer 2000 could be a circular buffer. This implementation allows data to be copied at the time the message is sent, provides a reduction in the memory footprint, and provides memory management through the use of a ring buffer.

It should be noted that the SENDER_BLOCK/FULL_DISCARD attribute has an effect on the memory usage. In particular, when the sender blocking protocol is in effect, the cumulative size of all unread messages (those waiting in destination ports) in a channel is the size of the biggest destination port (in this case, “port A”), and the messages are read in order (e.g., the oldest message will be the first one to ‘disappear’ from the set in the destination port). These characteristics allows a memory area as large as the largest destination port to be used to store all messages in this buffer, tracking the number of ‘read’ requests for each messages.

If the system of FIG. 8 were required to implement the full discard protocol, however, the above scheme is not as attractive. First, it is possible that older messages will remain in the buffer while more recent messages have already been read. This makes memory management more complex. In addition, with the full discard protocol, the cumulative size of all unread messages is, in the worst case, the cumulative size of all receiver ports, thus requiring a large memory buffer 2000.

In view of the increased complexity of implementing a full discard protocol with the configuration of FIG. 8, it may be preferable to maintain separate buffers for each destination port in embodiments which support the full discard protocol. FIG. 9 shows another scheme for implementing a queuing protocol which provides separate buffers for each destination port. In this embodiment, the sending partition 150a includes a sender process 300, and the receiving partition 150b includes a receiver process 301. Moreover, each of a source port 302 for the sending partition 150a and a destination port 303 for the receiving partition 150b comprises a circular buffer implemented in the core operating system 112. Each circular buffer is defined by a set of attributes including, for example, an identification of the partition with which it is associated, and whether it is a source port or a destination port.

A port driver 304 is implemented in the core operating system 112, and is operable to read messages stored in each source port 302 and to write the read messages into the destination port(s) 303 of the source port's channel (which correspond to the receiving partition(s) 150b). When the sending partition 150a needs to send a message to the receiving partition 150b, the sender process 300 formats a message, including, for example, a message descriptor to identify such information as source and destination of the message. The sender process 300 then writes the message into the corresponding source port 302 circular buffer in the core operating system 112 via a system call. The sender process 300 then updates a write pointer for the source port 302. The port driver 304 reads each message in the source port circular buffer 302 and writes each read message into the receiving port 303 circular buffer of the receiving partition 150b identified in the message descriptor of the message. According to the exemplary embodiment, of the present invention, each receiving partition 150b periodically reads the messages stored in the corresponding circular buffer comprising the receiving port 303 of the partition 150b (e.g., via a system call). A table of message descriptors can be maintained by the core operating system 112 to enable the core operating system 112 to track all messages.

Preferably, sender processes blocked on full ports (e.g., wherein one of the receive ports are full) and receivers processes blocked on empty ports (e.g., wherein there is no message being sent) are queued. Both the sender process and the receiver process are blocked in partitions (the user space), waiting to be notified by the port driver 304 of an interesting event (e.g., queue becomes non-full/message available). The notification is preferably implemented with the pseudo-interrupt mechanism described above (PortSendNotification, PortReceiveNotification).

In this exemplary embodiment, buffer overflow (e.g., erase of existing messages in the buffer) and buffer underflow (e.g., reading of invalid data) can be prevented in the following manner. Preferably, to prevent buffer overflow, the sender process 300 is allowed to write a new message (e.g., advance the write pointer) after the port driver 304 has notified it that space is available in the buffer 302. Buffer underflow can be prevented by allowing the port driver 304 to read a message after the sender process 300 has notified the port driver 304 that a new message is available.

Further implementation details of an exemplary implementation of the embodiment of FIG. 9 will now be described. It should be appreciated, however, that alternative implementation methods can also be used. At startup, the core operating system 112 allocates memory for all sending ports 302 and all receiving ports 303. In addition, each channel is allocated the following tables and variables:

1) a message queue for the port driver 304;

2) a reference to the port ID (e.g., for notification);

3) the minimum value of free space for all destination ports, minFreeSpace;

4) one structure per port that contains:

(a) a write pointer for its data buffer;

(b) a table (e.g., size=N) of message descriptors,

(c) an index for writing into the above table,

(d) the number of messages in its data buffer, and

(e) the amount of free space in the data buffer.

For purposes of illustration, Table 3 shows an exemplary message descriptor and Table 4 shows an exemplary data structure for a port:

TABLE 3

| Name | Meaning |
|---|---|
| Read index | Index to start of message |
| Length | Number of bytes in message |
| CRC | Optional Field, can be used to check message. |

TABLE 4

| typedef struc arincQueuingPort { | |
|---|---|
| int writeIndex; | /* index into data buffer */ |

| | |
|---|---|
| MSG_DESC msgTable[]; | /* Table of msg descriptors */ |

| | |
|---|---|
| int msgTableIndex; | /* index in msgTable */ |

| | |
|---|---|
| int numMsg; | /* number of msg in buffer */ |
| int bufferFreeSpace; | /* free space in buffer */ |
| int partitionID; | /* ID of partition */ |

| | |
|---|---|
| int vThreadsObjId; | /* address of port local object*/ |

Preferably, at partition startup, the data structures in the core operating system (e.g., including the port structures for port buffers 302, 303) are already initialized.

To initialize the “send port” functionality in the partition, the partition operating system 160 creates a local object (“send port local object”) (e.g., having the address VhreadsObjId) for interfacing with the port services and handling the processes. The local data structure for the local object comprises a list of blocked processes, the number of bytes needed by the first blocked process (e.g., a nextMsgSize), a local count of free bytes available in the source data buffer 302 (e.g., bufferFreeSpace), and a local count of messages in the source data buffer 302 (e.g., numMsgs). The partition operating system 160 then “registers” the ID of the local port object with the core operating system 112 in order to receive notification of events. This could be accomplished, for example, through a system call.

To initialize the “receive port”, the partition operating system creates another local object (“receive port local object”) having a data structure that includes a message queue to accommodate N messages (maximum allowed by the channel). If a new message becomes available in the receive buffer 303, the partition operating system will be notified using a pseudo-interrupt and the message will be posted to the message queue. The partition operating system “registers” the ID of the local port object (e.g., vThreadsObjId) with the core operating system 112 in order to receive this notification. This is accomplished through a system call.

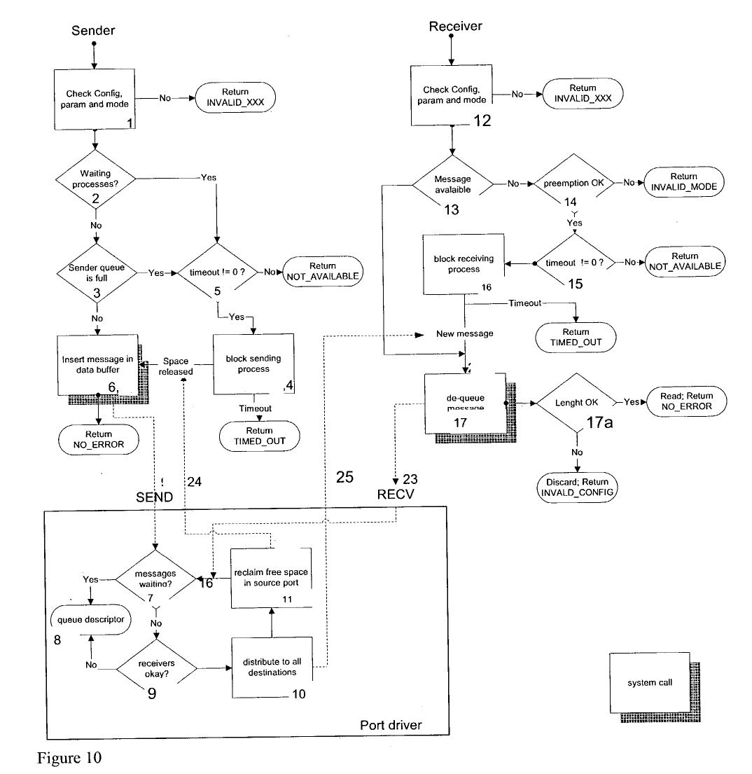

FIG. 10 is an exemplary flow chart for the send and receive processes described above. Upon request by a process in the partition to send a message to a given port 302, the sender process 300 (send port local object) checks all service parameters (e.g., type, length, timeout, port ID) and returns ERROR status if appropriate (Step 1). The sender process 300 then checks if any process in the partition is already waiting on this sender port 302 (Step 2). If there is, it returns a NOT_AVAILABLE status if a timeout expired (Step 5) or inserts the process into the blocked process queue maintained by sender process 302 according to the queue discipline (Step 4). If it is the first blocked process in the process queue, nextMsgSize is updated to match the size of the message to be sent (e.g., lenMsg).

If there is no process waiting on the sender port (step 2, “no”), the sender process 300 determines whether the send buffer is full (step 3). To do this, it checks bufferFreeSpace against the size of the message (e.g., lenMsg), and checks the number of messages in the send buffer against the maximum allowed number of messages in the port (e.g., N). If numMsg<=N, and lenMSG<bufferFreeSpace, the message can be sent (step 3, “no”), and therefore, bufferFreeSpace is decreased by the size of the message (e.g., lenMsg bytes) and numMsg is increased by 1. Preferably, this read/write operation is atomic (however, the partition could be “scheduled out” (i.e., descheduled) between reading and writing these variables). If there was not enough space for the message, the process may be queued (Step 3, “yes”).

Assuming the message can be sent, the message is inserted in the send data buffer 302 via a system call to the core operating system (Step 6). Preferably, the core operating system copy of bufferFreeSpace is checked against the message length. This second check is preferably performed in case the value of bufferFreeSpace in the partition is corrupted or out of date. If the message could not be inserted, an error is reported. Otherwise, in the core operating system, the writeIndex is copied and incremented, numMsg is incremented, and bufferFreeSpace is updated, preferably in an atomic operation (e.g., by identifying the operation as a critical section and blocking interruptions, e.g., via a core OS tasklock( )), and the new message is copied into the send data buffer 302 at the prior writeIndex value. A ‘SEND’ message is then sent to the port driver 304, embedding a message descriptor. The above referenced step can be implemented, for example, with a worker task in the core operating system.

As noted above, the port driver 304 performs the transfer operation. The port driver is a task that runs within the core operating system 112. In certain embodiments, the port driver 304 may be scheduled in the temporal partition 201 of the sending partition. In the exemplary implementation described hereinafter, however, execution of the port driver 304 is not limited to the temporal partition 201 of the sending partition. Port driver 304 executes a loop, receiving data through a message queue on the core operating system 112. The messages indicate either a ‘SEND’ operation or a ‘RECV’ operation. It should be noted that in this illustration, the port driver executes with a higher priority than the partition operating system 160, so it is not possible to have more than 2 SEND messages in the queue.

When the port driver is unblocked from the queue because a SEND message arrived, the message descriptor is obtained. If the source port numMsg is >1, a previous message is waiting to be delivered (Step 7), and the driver stores the message descriptor in the message table (msgTbl) (Step 8). If no messages are waiting, the driver 304 then checks the bufferFreeSpace and numMsg values of all destination ports 303 to determine if any of the destination port queues are full (Step 9). If any are full (“no”), the driver 304 stores the message descriptor in msgTbl of the source port 302 (Step 8).

Assuming that all of the destination buffers 303 are available, the driver 304 forwards the message to all destination ports 303 and updates the appropriate parameters (e.g., writeIndex, numMsg, bufferFreeSpace, etc.) accordingly (Step 10). Since a message has been delivered, free space is reclaimed in the sender data buffer (e.g., by updating numMsg, and bufferFreeSpace preferably in an atomic operation) (Step 11). The sender partition is also notified that free space is available (line 24), for example, via a pseudo interrupt to the partition of the source port, indicating how much memory was reclaimed.

When the port driver is unblocked because of a RECV message, this indicates that a process has de-queued a message from a destination queue 303 (dashed line 23). If the next message to be sent (first element of msgTbl of the source port) is smaller than the value of minFreeSpace (the space available in the destination port having the least free space), a message can be transferred and steps 7-11 can then be repeated as necessary to complete the transfer.

A receive operation primarily involves the processes of the destination partitions and the partition operating system 160. A receiver process 301 performing a receive operation first checks various parameters and arguments (e.g., portID, timeout, length etc.) and returns an error status if applicable (Step 12). The receiver process then attemps to get a message descriptor from the local message queue (Step 13). If no message descriptor is available in the queue, the receiver process pends on the queue for a period of time (Step 15-16). When destination partition receives a notification from the port driver (line 25), the partition operation system sends a message to the local port message queue. The message includes the ID of the receiver port object.

In any event, the process 301 then performs a system call (Step 17). Using the message descriptor received from the port 304 in the notification, the process copies the message data into user space in the partition; “numMsg” is decremented and “bufferFreeSpace” is incremented, preferably in an atomic operation, and a check is made to determine if the numMsg is now N−1 (less than the maximum number of messages) or if the update of bufferFreeSpace affects minFreeSpace. If it does, a RECV message is sent to the port driver indicating an opportunity to send a message (e.g., the destination port is unblocked) (line 23).

In certain embodiments, there is a maximum message length specified for the receive port, and the length of the message read from the destination buffer 303 in step 17 is checked in step 17a. In an embodiment utilizing step 17a, if the length of the message read from the destination buffer exceeds the maximum message length is exceeded, the message is discarded and an INVALID_CONFIG code is returned. If the maximum message length is not exceeded, a NO_ERROR code is returned.

It should be noted that this “RECV” message is an optimization and can be omitted if desired. The advantage provided by the RECV message is that by keeping track of the maximum size of a message that can be sent to all queues (minFreeSpace), it is not necessary for the port driver 304 to query each destination port 303 every time a message is to be transferred. In addition, the receiving process is optimized because the port driver 304 is notified of the available space and can therefore immediately proceed with the delivery of messages.

As mentioned above, when a message is transferred from the data buffer 302 of the source port to the data buffer 303 of the destination ports, the space is reclaimed and the port driver 304 notifies the sending partition of the new amount of space (line 24). To do this, the port driver 304 sends a pseudo interrupt to the sender partition. The interrupt indicates how much space was released in the data buffer 302. The partition operating system then updates the local copy of bufferFreeSpace/numMsg and dequeues any waiting processes. In this regard, the number of processes dequeued depends on the amount of space released, the previous amount of space available, and the messages length.

As noted above, the embodiment of FIG. 9 is effective for inter-partition communication using both the sender blocking protocol and the full discard protocol. An exemplary method for implementing the full discard protocol using the embodiment FIG. 9 will now be described. With this protocol, a message is sent to all ports as soon as the SEND_QUEUING_MESSAGE API (which as shown in FIG. 10, step 6, uses a system call) is made. If any of the ports are full, the message is not delivered to that port.

Preferably, the creation of ports is independent of the protocol. Therefore, an embodiment will be illustrated that utilizes the nomenclature described above with regard to the sender blocking protocol. It should be appreciated, however, that alternative implementations can also be used. In any event, the full discard protocol can be implemented with an identical data structure for the ports as was described above in connection with the sender blocking protocol. It should be noted, however, that the minimum value of free space for all destination ports, the source port data structure in the core operating system, and the source port data structure in the partition operating system are unnecessary for the full discard protocol and are not used in the illustrative embodiment described below. To implement destination ports for the full discard protocol, the partition operating system “registers” the ID of its local port object with the core operating system 112 as described above in connection with the sender blocking protocol in order to receive notification. This may be accomplished through a system call.

The send operation can be implemented in the same as described above for the sender blocking protocol. In this regard, the data buffer 302 of the source port is retained in case additional messages are sent before the port driver 304 has had an opportunity to transfer a message to the destination ports 303.

As described above with regard to the sender blocking protocol, the transfer operation is performed by the port driver 304. The processing of the transfer operation is similar to the sender blocking protocol. Preferably, a single port driver 304 handles all outgoing channels for one partition (e.g., including both sender blocking and full discard) and the driver 304 detects the protocol when the SEND message arrives. Assuming the message is sent in a channel using the full discard protocol, the driver 304 forwards the message to all destination ports. To implement this, the following procedure may be followed. First, the driver checks bufferFreeSpace and numMsg of each destination port. If any queue is full (e.g., bufferFreeSpace<lenMsg, or numMsg [symbol] N), the message for that destination port 303 is discarded. Otherwise, the message is copied to the destination port 303. In each destination port that receives the message, the message descriptor is stored in the port msgTbl, msgTblIndex is updated, numMsg is incremented, and bufferFreeSpace is reduced. A message is then sent to the destination partition with the vThreadsObjId (the receive local port data structure) and msgTblIndex. If another message is waiting in the source port 302, the above process is repeated until all messages are delivered.

The receive operation of the receive process 301 in the partition is similar to that of sender blocking protocol, except that no RECV message is sent to the port driver 304 because the send operation is never blocked. Therefore, there is little to be gained by the port driver 304 tracking the minFreeSpace or numMsg variables for the destination port 303.

As noted above, the system in accordance with a preferred embodiment of the present invention preferably supports both a queuing port model and a sampling port model. An exemplary sampling port model will now be discussed in further detail.

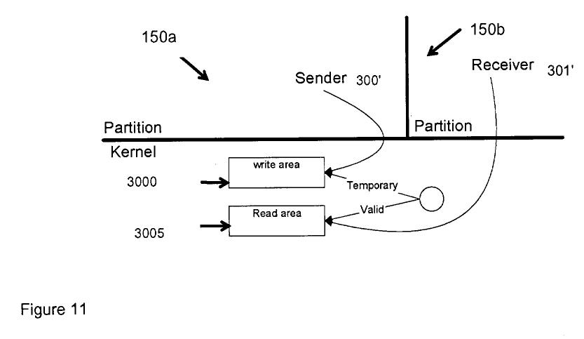

FIG. 11 shows an exemplary high level design for sampling ports. With a sampling port, there is only one message in any port and it can be overwritten at any time. Thus, for example, a receiver could be reading data, get scheduled out because its temporal partition 201 is over, and when the receiver starts reading again during the next temporal partition 201 for its partition, the data may have been replaced with a new message.

In the embodiment of FIG. 11, a double buffer system is provided which includes a first buffer 3000 and a second buffer 3005, wherein, at any given time, one of the buffers has a “temporary” status, and the other buffer has a “valid” status. The sender process 300′ uses the buffer with the “temporary” status, while the receiver processes 301′ uses the buffer having the “valid” status. When the sender 300′ has completed a write operation to the “temporary” status buffer, it changes the status of the buffers (e.g., valid becomes temporary and temporary becomes valid). The system may also include functionality (for example, a counter) for detecting whether the state of the current “valid” buffer has changed since a receiver 301′ has been scheduled out. Preferably, the sampling port is a non-blocking mechanism, with no interrupt or schedule latency within the partition operating systems or the core operating system.

Further implementation details of an exemplary implementation of the embodiment of FIG. 11 will now be described. It should be appreciated, however, that alternative implementation methods can also be used. Preferably, the creation of the sampling ports in the core operating system space is part of the core operating system initialization, and the sampling port objects are located in the core operating system space. In this example, a port comprises a data structure and two data buffers pointed to by pointers in the data structure. An exemplary data structure is shown in Table 5:

TABLE 5

| typedef struc arincSamplingPort { | |
|---|---|
| OBJ_CORE objCore; | /* object management */ |
| char * validData; | /* pointer to last message */ |
| char * tempData; | /* data being written */ |
| UINT32 counter; | |

```
    int partitionId; /* ID of source partition */
    int portSize;
    BOOL empty;
}
```

Preferably, the empty flag is set to TRUE when the port is created. Once data is written to the port, the flag is changed to FALSE. The validData and tempData variables point to two memory areas of “portSize” that are allocated from the core operating system space. These two memory areas comprise the buffers 3000, 3005. It should be noted that the “portSize” includes the size of a timestamp that is placed before the data in each buffer. At initialization, the “counter” variable is set to zero.

The partition operating system creates a local object at startup to create the sampling ports. An exemplary data structure for the partition's sampling port object is shown in Table 6. Each partition will include a sender port object to implement the sender process 300′ and a receiver port object to implement the receiver process 301′:

TABLE 6
typedef struc arincSamplingPort {

| | |
|---|---|
| OBJ_CORE objCore; | /* object |
| | management */ |
| PORT_DIRECTION_TYPE portDirection; | /* source or |
| | destination */ |
| SAMPLING_PORT_SIZE_TYPE portSize; | /* port size */ |
| SYSTEM_TIME_TYPE refreshPeriod; | /* period */ |
| OBJ_ID coreOsPort; | /* pointer to |
| | CoreOS port |
| | */ |

}

The coreOsPort variable points to the CoreOS port object (e.g., Table 5). The remaining attributes allow the receiver process 301′ to monitor the status of the sampling ports (e.g., is buffer 3000 currently a source (temporary) or destination (valid) port).

During a write operation, the sender process 300′ gets the ID of the CoreOS object (OBJ_ID CoreOSPort) and performs a system call. The core operating system checks the partition ID of the sender process 300′ and the ID of the port; writes a timestamp in the tempData buffer; writes the data in the tempData buffer; and atomically (e.g., taskLock( ) on the VxWorks AE task, or intLock( )) increments the counter and swaps the validData and tempData pointers. If this is the first write operation after initialization, the core operating system also changes the empty flag to FALSE.

During a read operation, the receiver process 301′ gets the ID of the CoreOS object and performs a system call. The core operating system performs the following steps. In step 1, the core operating system checks the ID of the port and checks the empty flag. If the empty flag is TRUE, there is no data to be read. Assuming the empty flag is FALSE, the core operating system proceeds to step 2. In step 2, the core operating system atomically reads the value of the validData pointer into P1 and reads the value of the counter into C1. Then, in step 3, the data and associated timestamp are read based upon pointer P1. Thereafter, in step 4, the value of the counter is read into C2. In step 5, C1 and C2 are compared. If C1 is equal to C2, the read operation was successful. If the value of C1 is not equal to the value of C2, then another write operation has occurred since the read operation in step 2 and the data is invalid. In that case, steps 2-5 are repeated until C1 is equal to C2. In order to ensure that valid data is eventually read, the time to execute steps above is preferably less than the duration of the temporal partition. In certain embodiments of the present invention, this can be ensured by setting a minimum duration of a temporal partition 201 as a function of a maximum message length.

In accordance with another implementation of the sampling ports, the data buffers 3000, 3005 (and the CoreOS port object) are placed within a protection domain that is freely readable by all domains but writable only through a system call. With this implementation, the sender process 300′ will incur the cost of a system call to change a write permission before and after the message is copied (one system call). However, the receiver would access the data without the cost of the system call.

Another implementation of the sampling port could involve the use of only a single data buffer. In this embodiment, the sender/receiver would access to the data buffer during its read/write. A mechanism would be provided to prevent a partition from being descheduled during a read or write operation (e.g., by limiting the read/write to a specified interval within a temporal partition).

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computer system, which comprises:
a core operating system;
a system space having a number of memory locations;
the core operating system arranged to partition the system space into a core operating system space and a number of partitions which include a plurality of partitions; and
a partition operating system and a partition user application in each partition, each partition operating system providing resource allocation services to the respective partition user application within the partition;
an interpartition communication system, the interpartition communication system interacting with the core operating system and each partition operating system to deliver messages between partitions.

2. The system of claim 1, wherein the interpartition communication system further includes:
one or more data buffers in the core operating system space, and
a sender process and a receiver process in each partition of the plurality of partitions, the sender process in each partition executable to deliver messages for one or more destination partitions of the plurality of partitions to one or more of the one or more data buffers, and the receiver process in each partition executable to retrieve messages, for which its respective partition is one of the destination partitions, from one or more of the one or more data buffers

3. The system of claim 2, wherein at least one of the number of partitions includes no sender process and no receiver process.

4. The system of claim 2, wherein at least one of the number of partitions includes a sender process and no receiver process.

5. The system of claim 2, wherein at least one of the plurality of partitions includes a receiver process and no sender process.

6. The system of claim 2, further comprising
a port driver in the core operating system space;
wherein the one or more data buffers include, for each partition of the plurality of partitions, a corresponding source buffer and a corresponding destination buffer,
wherein the sender process in each partition of the plurality of partitions is executable to deliver messages to its corresponding source buffer utilizing its partition operating system and the core operating system;
wherein the receiver process in each partition of the plurality of partitions is executable to retrieve messages from its corresponding destination buffer utilizing its partition operating system and the core operating system;
wherein the port driver is executable to transfer messages from each of the source buffers to one or more of the destination buffers, based upon the destination partition of each message transferred, utilizing the core operating system.

7. The system of claim 6, wherein one of the partitions include a plurality of corresponding source buffers.

8. The system of claim 6, wherein one of the partitions include a plurality of corresponding destination buffers.

9. The system of claim 6, wherein, if a message in a first one of the source buffers is for a plurality of the destination buffers, and one of the plurality of destination buffers is full, the message is not sent to any of the plurality of destination buffers.

10. The system of claim 6, wherein if a message in a first one of the source buffers is for a plurality of the destination buffers, and one of the plurality of destination buffers is full, the message is sent to each one of the plurality of destination buffers except said one of the destination buffers.

11. The system of claim 6, wherein each sender process maintains information indicative of an available memory space in its corresponding source buffer, and, wherein the sender process only delivers a message to its corresponding source buffer if said information indicates that said available memory space is sufficient to store the message.

12. The system of claim 11, wherein, when the port driver transfers a message out of one of the source buffers, the port driver notifies the partition operating system for the partition corresponding said one source buffer, and, based upon said notification, the corresponding sender process updates said information.

13. The system of claim 1, wherein the one or more data buffers include, for each partition of the plurality of partitions, a corresponding source buffer and a corresponding destination buffer,
wherein the sender process in each partition of the plurality of partitions is executable to deliver messages to its corresponding source buffer utilizing its partition operating system and the core operating system;
wherein the receiver process in each partition of the plurality of partitions is executable to retrieve messages from its corresponding destination buffer utilizing its partition operating system and the core operating system.

14. The system of claim 1, further comprising a plurality of channels, each channel including a source port and one or more destination ports, each source port and each destination port associated with one of the partitions, wherein messages are sent from each source port to all destination ports in said each source port's channel.

15. The system of claim 14, wherein no source port is in more than one channel and no destination port is in more than one channel.

16. The system of claim 14, wherein the interpartition communication system further includes:
a data buffer in the core operating system space for each channel, and
a sender process and a receiver process in each partition of the plurality of partitions, the sender process in each partition of the plurality of partitions executable to deliver messages for each of its associated source ports to the data buffer corresponding to the channel for said each associated source port, and the receiver process in each partition of the plurality of partitions executable to retrieve messages for each of its associated destination ports from the data buffers corresponding to the channel for said each associated destination port.

17. The system of claim 16, wherein the data buffer for each channel includes a source buffer and a destination buffer.

18. The system of claim 16, further comprising
a port driver in the core operating system space;
wherein the data buffer includes, for each channel, a corresponding source buffer and a corresponding destination buffer,
wherein the sender process in each partition of the plurality of partitions is executable to deliver messages for each of its associated source ports to the corresponding source buffer utilizing its partition operating system and the core operating system;
wherein the receiver process in each partition of the plurality of partitions is executable to retrieve messages for each of its associated destination ports from the corresponding destination buffer utilizing its partition operating system and the core operating system;
wherein, for each of the source buffers, the port driver is executable to transfer messages from said each source buffer to each destination buffer in the channel associated with said each source buffer.

19. The system of claim 2, wherein the sender process includes a plurality of sender processes.

20. The system of claim 2, wherein the receiver process includes a plurality of receiver processes.

21. The system of claim 16, wherein the sender process includes a plurality of sender processes.

22. The system of claim 16, wherein the receiver process includes a plurality of receiver processes.

23. The system of claim 14, further including comprising, for each source port, a port attribute in a port data structure, wherein, if the port attribute has a first value, if one of the destination ports in a source port's channel is full, no message is sent from said source port to any of the destination ports in said source port's channel; and wherein, if the port attribute has a second value, if one of the destination ports in said source port's channel is full, a message sent from said source port is sent to each one of the destination ports in said each source port's channel except said one of the destination ports.

24. The system of claim 1, wherein each partition is implemented as a protection domain.

25. A computer system, which comprises
a core operating system;
a system space having a number of memory locations;
the core operating system arranged to partition the system space into a core operating system space and a plurality of partitions;
a partition operating system and a partition user application pair in each partition, whereby the partition operating system, partition user application pairs of the partitions are spatially partitioned from each other;
an interpartition communication system, the interpartition communication system interacting with the core operating system and each partition operating system to deliver messages between partitions.

26. The system of claim 25, wherein each partition is implemented as a protection domain.

27. A method for operating a computer system, comprising the steps of:
implementing a core operating system;
providing a system space having a number of memory locations;
operating the core operating system to partition the system space into a plurality of partitions; and
implementing a partition operating system and a partition user application pair in each partition, whereby the partition operating system, partition user application pairs of the partitions are spatially partitioned from each other;
operating each partition operating system of each pair to provide resource allocation services to the respective partition user application within the partition;
implementing an interpartition communication system, the interpartition communication system having components in the system space and in each partition, the interpartition communication system interacting with the core operating system and each partition operating system to deliver messages between partitions.

28. The method of claim 27, wherein each partition is implemented as a protection domain.

29. A method for operating a computer system, comprising the steps of:
implementing a core operating system;
providing a system space having a number of memory locations;
operating the core operating system to create a number of protection domains to partition the system space; and
implementing a partition operating system and a partition user application pair in each partition, whereby the partition operating system, partition user application pairs of the partitions are spatially partitioned from each other;
operating each partition operating system of each pair to provide resource allocation services to the respective partition user application within the partition;
operating the core operating system to schedule the partitions such that the partition operating system, partition user application pairs are temporally partitioned from each other;
implementing an interpartition communication system, the interpartition communication system having components in the system space and in each partition, the interpartition communication system interacting with the core operating system and each partition operating system to deliver messages between partitions.

30. A method for operating a computer system, which comprises the steps of:
implementing a core operating system; and
implementing a system space having a number of memory locations;
implementing the core operating system to create a number of protection domains to partition the system space into a core operating system space in a system protection domain and a plurality of partitions in a corresponding plurality of partition protection domains; and
providing one or more data buffers in the system protection domain;
implementing an interpartition communication system for transmitting a message from a source partition of the plurality of partitions to one or more destination partitions of the plurality of partitions, the interpartition communication system implemented via a sender process in each source partition protection domain and a receiver process in each destination partition protection domain, the sender process in each source partition protection domain executable to deliver messages for one or more destination partitions to one or more of the one or more data buffers, and the receiver process in each destination partition protection domain executable to retrieve messages, for which its respective partition is one of the destination partitions, from one or more of the one or more data buffers.

31. A computer system, which comprises:
a core operating system; and
a system space having a number of memory locations;
the core operating system arranged to create a number of projection domains to partition the system space into a core operating system space in a system protection domain and a plurality of partitions in a corresponding plurality of partition protection domains; and
one or more data buffers in the system protection domain;
an interpartition communication system for transmitting a message from a source partition of the plurality of partitions to one or more destination partitions of the plurality of partitions, the interpartition communication system including a sender process in each source protection domain and a receiver process in each destination partition protection domain, the sender process in each source partition protection domain executable to deliver messages for one or more destination partitions to one or more of the one or more data buffers, and the receiver process in each destination partition protection domain executable to retrieve messages, for which its respective partition is one of the destination partitions, from one or more of the one or more data buffers.

32. A computer system, which comprises:
a core operating system;
a system space having a number of memory locations;
the core operating system arranged to partition the system space into a core operating system space and a plurality of partitions; and
a partition operating system and a partition user application in each partition, each partition operating system providing resource allocation services to the respective partition user application within the partition;
an interpartition communication system, the interpartition communication system interacting with the core operating system and each partition operating system to deliver messages between partitions.
